(19) United States
(12) Patent Application Publication
(10) Pub. No.: US 2005/0025120 A1
(43) Pub. Date: Feb. 3, 2005

(54) Event scheduling for multi-port xDSL transceivers

(76) Inventors: Anthony J.P. O'Toole, Los Gatos, CA (US); Mark Hashemi, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/871,896

(22) Filed: Jun. 18, 2004

Related U.S. Application Data
(60) Provisional application No. 60/479,655, filed on Jun. 18, 2003.

(51) Int. Cl. H04L 12/28

(52) U.S. Cl. 370/351

(57) ABSTRACT

A multi-port DSL system terminates a plurality of DSL channels that are multiplexed through a data path of a DSL transceiver. In one embodiment, data path events are generated based on the data transmission in each of the channels. When the data path becomes available to process a next data symbol, the data path processes a data symbol for the channel indicated by the data path events. Optionally, the data path may process a data symbol for a particular channel only if a predetermined amount of time has elapsed since a data symbol was processed for that data channel.

### CROSS REFERENCE TO RELATED APPLICATIONS

This application claims the benefit of U.S. Provisional Application No. 60/479,655, filed Jun. 18, 2003, which is incorporated by reference in its entirety.

### BACKGROUND

1. Field of the Invention

The invention is generally related to digital subscriber line (DSL) transceivers, and more particularly to event scheduling for multi-port DSL transceivers to coordinate control and data path events for a plurality of channels of data processed by a multi-port DSL transceiver.

2. Background of the Invention

At the network side of an access connection, many connections can be terminated in a single piece of equipment. To keep within space constraints, multiple lines are typically terminated on a single chipset of the equipment. In the case of an xDSL modem, such as an ADSL modem, there are two basic approaches to architecting this type of device. The first approach is to replicate the modem function n times, where n is the number of lines terminated, and the second approach is to create a faster modem that can be time-multiplexed among the n channels. In practice, most implementations are a combination of these two approaches. The time sharing approach tends to be better from a density perspective, but it can be more complicated to design—especially when the rate at which individual lines need to be processed varies over time, as is the case for DMT modems (e.g., as described in ITU-T G.992.1).

In DMT modems, where the symbol rate is slow (e.g., around 4 kHz) and the symbol size is large, certain operations must take place on a complete symbol. The symbol rate varies depending on whether cyclic prefix is included (e.g., whether the modem is in a training or a show time mode), creating complexity in a multi-channel DSL system. In a typical DMT modem there are control functions, which tend to be performed by some level of processor, and computational functions, which may be performed by autonomous hardware blocks (e.g., data path functions). Where the control path is performed by a processor, the coordination of control and data is normally complicated by the variability of the response time of the processor rather than the more predictable data path. The control functions performed by the processor must be managed so that they occur on specific symbol boundaries in the data path to keep alignment with corresponding changes in the remote modem. Moreover, it is desirable to minimize buffering to reduce die size and delay in the modem.

It is thus desirable to provide a multi-port DSL system that can efficiently schedule for each a plurality of data channels processing events to occur in the transmit path and/or in the receive path of the system. It is further desirable that such a system spread out over time the processing of the symbols for each of the channels to reduce the peak processing power required of the system. To avoid errors and inefficiencies in the system, the events should not be scheduled too early or too late.

### SUMMARY OF THE INVENTION

In a multi-port DSL system that terminates a plurality of DSL lines multiplexed through a data path of the DSL system, the processing of the data from each of the channels through the data path is scheduled to avoid errors and inefficiencies. In one embodiment, the data path is a receive path of a DSL receiver, and in another embodiment the data path is a transmit path of a DSL transmitter.

In one embodiment, a multi-port DSL system terminates a plurality of DSL channels that are multiplexed through a data path of a DSL transceiver. Data path events are generated based on the data transmission in each of the channels. When the data path becomes available to process a next data symbol, the data path processes a data symbol for the channel indicated by the data path events. Optionally, the data path may process a data symbol for a particular channel only if a predetermined amount of time has elapsed since a data symbol was processed for that data channel.

### BRIEF DESCRIPTION OF THE DRAWINGS

FIG. 1 is a schematic diagram of a DSL network in which a plurality of data connections are terminated at a central office (CO), in accordance with an embodiment of the invention.

FIG. 2 is a partial schematic diagram of equipment at a CO for terminating multiple DSL lines, in accordance with an embodiment of the invention.

FIG. 3 is a schematic diagram of a transmit data path of a DSL transceiver and a scheduling system thereof, in accordance with an embodiment of the invention.

FIG. 4 is a timing diagram of the symbol transmission events for an example DSL signal for each of training and show time modes, in accordance with an embodiment of the invention.

FIG. 5 is a timing diagram for a plurality of data channels showing the timing of event generation for scheduling data path events, in accordance with an embodiment of the invention.

### DETAILED DESCRIPTION OF THE PREFERRED EMBODIMENTS

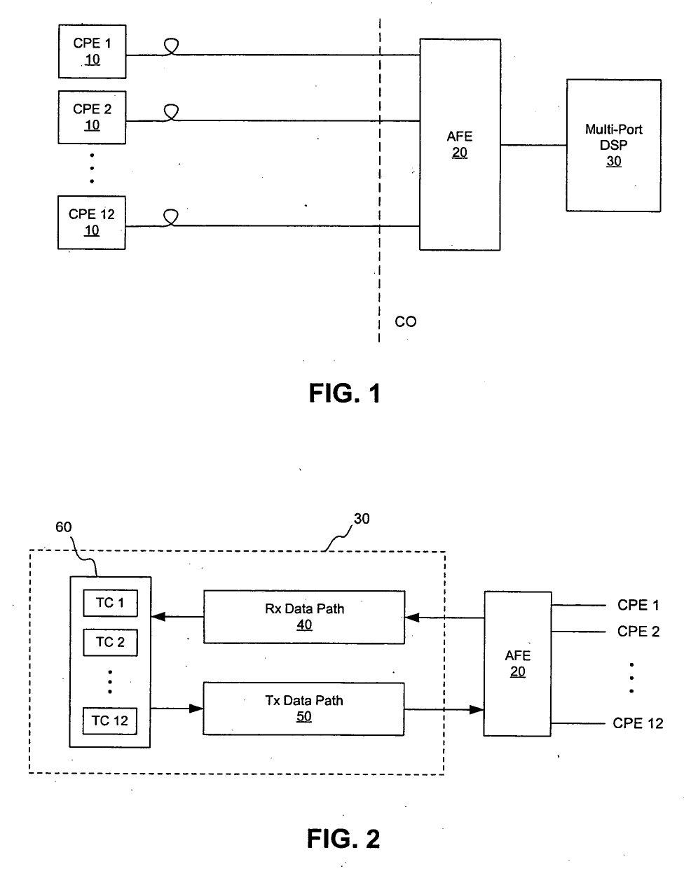

As shown in FIG. 1, a plurality of DSL connections are terminated at a central office (CO). Each DSL connection couples a customer premises equipment (CPE) modem 10 to the CO to provide a data channel therebetween. As is known, a CO typically provides DSL data service to a number of different customers, where each customer communicates with the CO using a CPE modem 10 via a local loop, or twisted copper pair connection. In one embodiment of the invention, a plurality of data channels from multiple CPE modems 10 are time-multiplexed (e.g., by an analog front end (AFE) 20) and then passed to the CO equipment for processing. The CO equipment includes a multi-port digital signal processor (DSP) 30 that can process the data signals received from and/or transmitted to the CPE modems 10 on each of the data channels. For purposes of clarity, FIG. 1 does not show all of the CO equipment used to process DSL signals.

A more detailed diagram of an embodiment of the CO equipment is shown in FIG. 2. Analog signals are received over each subscriber line from a CPE modem 10 by an analog front end (AFE 20) 60 at the CO. In a receive direction the AFE 20 converts the received analog data signal into a digital signal and passes the received data through a receive data path 40. Although the receive data path 40 may include any number of functional blocks depending on the application, such a receive path 40 typically includes one or more of a decimator, an echo canceller, a time domain equalizer, and an inverse mapper. Once the functions in the receive data path 40 are performed, the processed data are passed through a transport control (TC) layer processing block 60.

In the transmit direction, the multi-port DSP 30 provides a data signal to be transmitted to one or more of the CPE modems 10. These data signals are passed through the TC layer processing block 60 and then through the transmit data path 50 for processing. Although the transmit data path 50 may include any number of functional blocks depending on the application, such a transmit path 50 typically includes one or more of a mapper, an inverse transform (IFFT) block, a filter, and a peak-to-peak reduction block. The digital data signals are converted into analog signals by the AFE 20 for transmission to a CPE modem 10 over the local loop.

In a typical DSL system, the data are organized into discrete units called symbols. When the data channels are time-multiplexed for being processed through the receive path 40 or the transmit path 50 of the CO's DSL transceiver equipment, they are preferably divided along their symbol boundaries so that whole symbols are processed together. It can be appreciated, however, that when the multi-port DSP 30 has to support many data channels (e.g., twelve channels), scheduling the processing of the data symbols of each channel through the system can become difficult. Symbols for a channel in the receive direction should not be scheduled too early, or the receive path 40 will be idle while waiting for the symbol to be received (causing a bottleneck delay for the other channels). But these symbols should not be scheduled to late either, as the buffers that contain the received symbols waiting for processing can overflow. Similarly, to avoid buffer overflow or holding up the system, symbols for a channel in the transmit direction should not be scheduled for processing in the data path too early or too late.

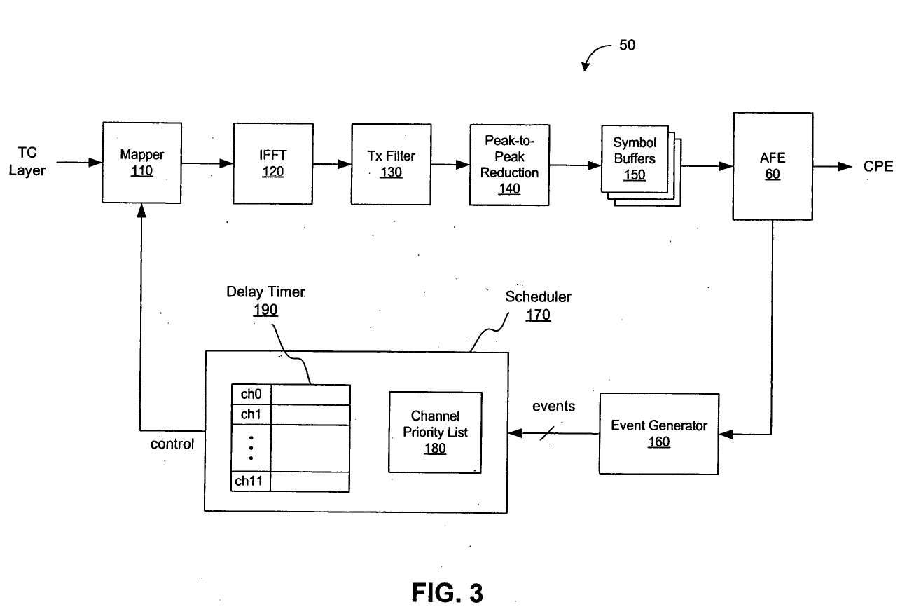

FIG. 3 illustrates an embodiment of a portion of the transmit data path 50 of a DSL transceiver that includes a system for scheduling the data to be processed through the transmit data path 50. It will be appreciated that a corresponding scheduling system can be similarly implemented in the receive data path 40 of the DSL transceiver. In the embodiment of the transmit data path 50 shown in FIG. 3, the main processing blocks of the transmit path 50 include a mapper 110, coupled to an IFFT block 120, coupled to a transmit filter 130, coupled to a peak-to-peak reduction block 140. Each of processing blocks is well known in the art, and in alternative embodiments the path 50 may include various other combinations of processing blocks. These processing blocks may be thought of as a processing pipeline, in which each block is a stage of the processing. Digital data from the DSP 30 are sent through the pipeline after the TC layer processing stage. Discrete units of digital data to be processed in this pipeline, typically packaged as a data symbol, are associated with a particular data channel. Accordingly, data symbols for different channels may be processed simultaneously in different blocks of the pipeline. In this way, each block can be implemented as a processing engine, a data path element that processes a symbol independently of the channel to which the symbol belongs.

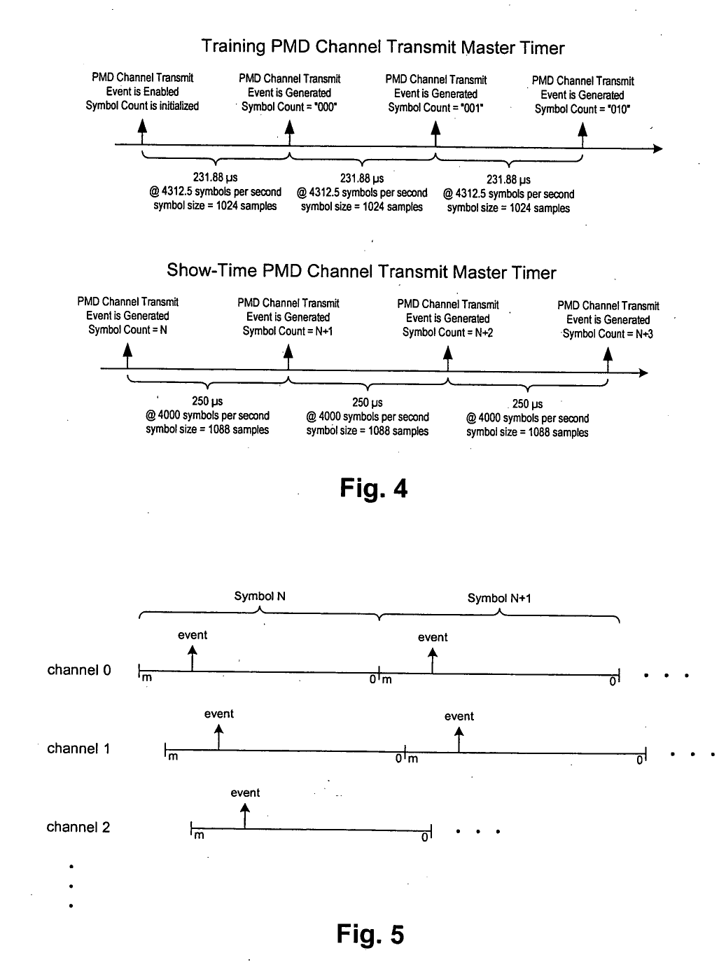

Preferably, the data path 50 is sufficiently fast to accommodate the maximum number of channels for which the multi-port DSP 30 is designed; otherwise, the data path 50 would be a bottleneck for the system. To accommodate each of the channels under all conditions, the data path 50 is preferably designed to handle the most demanding conditions for the multi-channel DSL system. Typically, this is when each of the channels is in a training or initialization mode. FIG. 4 shows a comparison between the symbols in an ADSL2 system for a training mode and those for a show-time mode. It can be seen that the symbol size for symbols in a training mode is smaller than that for show-time symbols, so the rate at which training mode symbols are transmitted is faster. Accordingly, under the most demanding conditions, the data path 50 should be sufficiently fast to process a training mode symbol for each channel during a single training mode symbol period. In the example system in which the multi-port DSP 30 is designed to accommodate twelve channels, each element in the data path 50 should be able to process twelve training mode symbols in this period.

Because the symbols are processed before they are necessarily ready to be transmitted over the local loop, symbols buffers 150 are coupled to the data path 50 to store the processed symbols temporarily while they wait to be transmitted. Each channel may have its own symbol buffer 150 or may have an allocated memory region in a shared symbol buffer 150. When a symbol for a particular channel is processed by the pipeline, it is stored in the corresponding symbol buffer 150. When the DSL transceiver is ready to transmit the symbol, the symbol is removed from the buffer 150, converted to an analog signal by the AFE 60, and then transmitted to the corresponding CPE modem 10. Because the symbol processing and symbol transmission are asynchronous, it is apparent that scheduling the processing of symbols based on the need for symbols to transmit is important.

Accordingly, an embodiment of the DSL transceiver includes an event generator 160 and a scheduler 170, as shown in FIG. 3. The event generator 160 is coupled to the AFE 60 and has access to the timing of the transmission of the symbols of each channel. Although shown in separate functional blocks, it can be appreciated that the scheduler 170 and event generator 160 may be implemented as parts of other components. For example, the event generator 160 may be a functionality of the AFE 60, and the scheduler 170 may be implemented in the mapper 110.

The event generator 160 generates a data path event for each channel based on the status of the data transmission in the channel. As used in this context, the status of the data transmission is not limited to any direction and thus includes the status of data reception in the channel in the case of scheduling events for the receive data path 40. In one embodiment, a data path event identifies a channel for which a next data symbol is to be processed in the data path 50. The data path event effectively orders the processing of a new symbol for that channel. The data path event may take a number of forms, such as a signal that encodes the channel with which the event is associated. FIG. 5 illustrates the timing of event generation for scheduling data path events for a plurality of data channels, in accordance with one embodiment. In one embodiment, the events are generated for each channel at a predetermined time during the transmission of a symbol for the channel. Whether this predetermined time has occurred can be determined, for example, by subtracting a current sample of the symbol being transmitted from the symbol size (m, as shown in FIG. 5). This predetermined time may be loaded into a programmable register.

Using data path events in this way, the processing of symbols through the data path 50 can be scheduled before the output symbol buffer becomes free. Because the data path 50 has a minimum delay associated with it due to the typical processing functions in the data path 50, a given symbol requires a certain minimum time to be processed through the data path 50. Therefore, this processing can be started before space is available in the output buffer 150 to accept the result, and by the time the computations are performed the output buffer 150 is free to store a processed symbol. In one embodiment, the time advance is programmable, which allows for variations in the processing path to be accommodated for an individual channel, where the size of the IFFT or filter may change the path delay. Scheduling the data path events to occur before the associated symbol buffer for the particular channel allows for a smaller output buffer thereby saving die area. It also reduces the maximum delay through the data path, and thus through the DSL transceiver, which has a positive impact on data throughput.

The scheduler 170 is coupled to receive the generated data path events from the event generator 160. In one embodiment, the scheduler 170 includes a channel priority list 180 for prioritizing the received data path events. When the scheduler 170 receives a data path event from the event generator 160, the scheduler 170 adds the event to the channel priority list 180. In one embodiment, the channel priority list 180 is a FIFO buffer that implements a first-in-first-out ordering scheme. In this way, the events are processed in the order receiver from the event generator 160. When the data path 50 becomes available to process a next data symbol, the scheduler 170 sends a control signal to the data path 50 that indicates the channel for which the data path 50 should process the next symbol. Preferably, the channel indicated by this control signal is determined according to the channel priority list 180, where the oldest entry in the list 180 has the highest priority. In this way, the channel having the oldest generated event is the next to have a symbol processed in the data path 50.

In one embodiment, the scheduler 170 further includes a delay timer 190, which tracks the amount of time since a data symbol was last processed for each data channel. In this embodiment, the scheduler 170 will cause the data path 50 to process a data symbol for a channel only if the delay timer 190 indicates that a predetermined amount of time has elapsed since a data symbol was last processed for that data channel. In the case where the data path 50 is ready to process a next symbol but the predetermined delay has not elapsed for the next channel in the channel priority list 180, the scheduler 170 may send a control signal to the data path 50 to process a symbol for the next channel in the channel priority list 180, subject to this delay timer condition.

The delay timer 190 may be implemented as a plurality of countdown timers, each countdown timer corresponding to one of the channels in the system. When a symbol for a channel is processed in the data path 50, the scheduler 170 loads a value into the channel's corresponding countdown timer. The value loaded into the countdown timer may be the number of clock cycles that corresponds to the predetermined amount of time for implementing the desired delay.

The delay timer 190 may be useful in avoiding certain errors caused by scheduling channels based purely on the need for data (in the transmit path) or on the arrival of data (in the receive path). Although such a scheme tends to be the most efficient, it can cause problems for the control path. For example, if channel 1 is running without cyclic prefix (e.g., early stages of training), and all other channels are running with cyclic prefix, channel 1 will be running faster than the other channels. It can be appreciated that when a first channel 1 event is slightly after the other channels' events and the second channel 1 event is slightly before the other channels' events, the result will be that the system will schedule channel 1 events back-to-back. This is a problem, for example, if a configuration change needs to be made by the control path between these two events, there is very little time to schedule these changes, making the timing of the control path very difficult to manage. The scheduler 170 solves this problem by introducing a delay timer 190 between successive events of each timer, as described above. In the scenario above, the delay timer 190 causes the second event to be held off until the timer 190 expires, allowing other symbols to be processed and thus guaranteeing a minimum separation in which the control functions can be managed.

Although embodiments of the invention have been illustrated with particular examples, the invention is not intended to be limited thereby. For example, in several embodiments the system processes twelve data channels; however, the techniques and equipment described herein can be used to schedule processing events for any number of multiplexed data channels. In addition, particular values used herein such as symbol sizes and data rates are based on current standards and are used to illustrate embodiments of the invention by example; these parameters can be varied based on future standards or other desired results without deviating from the scope of the invention.

Accordingly, the foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. A multi-port DSL transceiver comprising:
a data path for processing data symbols for a plurality of data channels;
an event generator configured to generate data path events based on the status of the data transmission in each of the channels, each data path event identifying a channel for which a next data symbol is to be processed; and
a scheduler coupled to receive data path events from the event generator, the scheduler prioritizing the received data path events and, responsive to the data path becoming available to process a next data symbol, requesting that the data path process a data symbol for the channel indicated by the prioritized data path events.

2. The DSL transceiver of claim 1, further comprising:
a delay timer configured to track a time since a data symbol was processed for each data channel;
wherein the scheduler causes the data path to process a data symbol for a channel only if the delay timer indicates that a predetermined delay has elapsed since a data symbol was processed for that data channel.

3. The DSL transceiver of claim 1, wherein the event generator generates data path events at a predetermined time during the transmission of a symbol for each channel.

4. The DSL transceiver of claim 3, wherein the predetermined time is programmable.

5. The DSL transceiver of claim 1, wherein the scheduler prioritizes the received data path events by adding the events to an ordered list.

6. The DSL transceiver of claim 5, wherein the scheduler, responsive to the data path becoming available to process a next data symbol, requests processing of symbol for the channel associated with the next event in the ordered list.

7. The DSL transceiver of claim 2, wherein the delay timer comprises a plurality of countdown timers each associated with a channel, each countdown timer being initialized with the predetermined delay when a symbol for the associated channel is processed in the data path.

8. The DSL transceiver of claim 7, wherein whether the predetermined delay has elapsed for a particular data channel is determined according to the value of the countdown timer associated with the channel.

9. The DSL transceiver of claim 1, wherein the data path is a receive data path of the DSL transceiver.

10. The DSL transceiver of claim 1, wherein the data path is a transmit data path of the DSL transceiver.

11. A system for scheduling data symbols for a plurality of data channels to be processed through a data path of a DSL transceiver, the system comprising:
means for generating data path events for each data channel, a data path event indicating that a data symbol is to be processed by the data path of the DSL transceiver;
means for ordering the generated data path events; and
means, responsive to the data path of the DSL transceiver becoming available to process a data symbol, for requesting that the data path process a symbol for the channel corresponding to a next data path event in the ordered data path events.

12. The system of claim 11, further comprising:
means for tracking a time since a data symbol was processed for each data channel, wherein the data path is requested to process a symbol for a channel only if a predetermined delay has elapsed since a data symbol was processed for that data channel.

13. A method for scheduling data symbols for a plurality of data channels to be processed through a data path of a DSL transceiver, the method comprising:
generating data path events for each data channel, a data path event indicating that a data symbol is to be processed by the data path of the DSL transceiver;
ordering the generated data path events; and
responsive to the data path of the DSL transceiver becoming available to process a data symbol, requesting that the data path process a symbol for the channel corresponding to a next data path event according to the ordering of the generated data path events.

14. The method of claim 13, further comprising:
tracking a time since a data symbol was processed for each data channel; and
causing the data path to process a symbol for a channel only if a predetermined delay has elapsed since a data symbol was processed for that data channel.

15. The method of claim 13, wherein data path events are generated for each data channel at a predetermined time during the transmission of a symbol the channel.

16. The method of claim 13, wherein ordering the data path events comprises adding the data path events to a FIFO list.

17. The method of claim 15, wherein tracking a time since a data symbol was processed for each data channel comprises:
initializing a countdown timer associated with the channel with the predetermined delay when a symbol for the associated channel is processed in the data path, whether the predetermined delay has elapsed indicated by a value of the countdown timer.

18. The method of claim 13, wherein the data path is a transmit data path of the DSL transceiver.
